(19) United States
(12) Patent Application Publication
(10) Pub. No.: US 2007/0257917 A1
(43) Pub. Date: Nov. 8, 2007

(54) Method, system, and computer program product for preventing characters from bypassing content filters

(75) Inventor: Dale M. Schultz, Chelmsford, MA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/416,751

(22) Filed: May 3, 2006

(51) Int. Cl. G06T 11/00

(52) U.S. Cl. 345/467

(57) ABSTRACT

The present invention provides a method, system, and computer program product for preventing characters (E.g., full width characters) from bypassing content filters. A method in accordance with an embodiment of the present invention includes: obtaining text to be analyzed; normalizing the text by subtracting an offset from a numeric codepoint of each character in the text falling within a predetermined range; and analyzing the normalized text using the content filter.

### BACKGROUND OF THE INVENTION

1. Field of the Invention

The present invention generally relates to content filtering, and more specifically relates to a method, system, and computer program product for preventing characters (e.g., full width characters) from bypassing content filters.

2. Related Art

Unsolicited email (e.g., spam) or undesired web content is often filtered out by software that looks for certain keywords in the content (e.g., subject and body) of an email or content of a web page. However, if these keywords are written using full width Latin equivalents and/or other types of equivalents, the keywords are not recognized as target words and are not detected.

Unicode is a universal character encoding, maintained by the Unicode Consortium. This encoding standard provides the basis for processing, storage and interchange of text data in any language in all modern software and information technology protocols. As known in the art, a Unicode character is referenced using a “U+” followed by a hexadecimal number indicating the character's codepoint in the Unicode code space. Additional information regarding Unicode can be found at www.unicode.org.

In Unicode, ASCII characters fall into the range of U+0020 through U+007F. ASCII characters also have a set of full width ASCII equivalent characters in the range of U+FF01 through U+FF5E. These full width characters are used for expressing Latin U+text that is embedded in Asian text, such as Japanese and Chinese, and are designed to have the same width as the Asian characters, thus allowing the text to stay in neat columns. Modern email and web browsing software is capable of displaying these characters, allowing text written with these characters to be read by anyone who can read a Latin based script. Unfortunately, these full width equivalent characters can also be used to “disguise” words in order to bypass filtering devices such as email or web page content filters. Other types of characters can be used in a similar way to bypass filtering devices.

Accordingly, a need exists for a way to prevent characters from bypassing content filters.

### SUMMARY OF THE INVENTION

The present invention provides a method, system, and computer program product for preventing characters (e.g., full width characters) from bypassing content filters. In particular, in accordance with a first embodiment of the present invention, full width ASCII character equivalents in the range of U+FF01 through U+FF5E are converted (i.e., normalized) to their corresponding ASCII characters in the range of U+0021 through U+007E before any content filtering is performed. The present invention can also be applied to other ranges of Unicode characters that are arranged from A to Z in order to prevent such characters from bypassing content filters.

A first aspect of the present invention is directed to a method for preventing characters from bypassing a content filter, comprising: obtaining text to be analyzed; normalizing the text by subtracting an offset from a numeric codepoint of each character in the text falling within a predetermined range; and analyzing the normalized text using the content filter.

A second aspect of the present invention is directed to a system for preventing characters from bypassing a content filter, comprising: a system for obtaining text to be analyzed; a system for normalizing the text by subtracting an offset from a numeric codepoint of each character in the text falling within a predetermined range; and a system for analyzing the normalized text using the content filter.

A third aspect of the present invention is directed to a program product stored on a computer readable medium for preventing characters from bypassing a content filter, the computer readable medium comprising program code for performing the steps of: obtaining text to be analyzed; normalizing the text by subtracting an offset from a numeric codepoint of each character in the text falling within a predetermined range; and analyzing the normalized text using the content filter.

A fourth aspect of the present invention is directed to a method for deploying an application for preventing characters from bypassing a content filter, comprising: providing a computer infrastructure being operable to: obtain text to be analyzed; normalize the text by subtracting an offset from a numeric codepoint of each character in the text falling within a predetermined range; and analyze the normalized text using the content filter.

The illustrative aspects of the present invention are designed to solve the problems herein described and other problems not discussed

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a flow diagram of an illustrative process for preventing characters from bypassing content filters in accordance with an embodiment of the present invention.

FIG. 2 depicts a general flow diagram of an illustrative process for normalizing text in accordance with an embodiment of the present invention.

FIG. 3 depicts a more detailed flow diagram of an illustrative process for normalizing text in accordance with an embodiment of the present invention.

FIG. 4 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

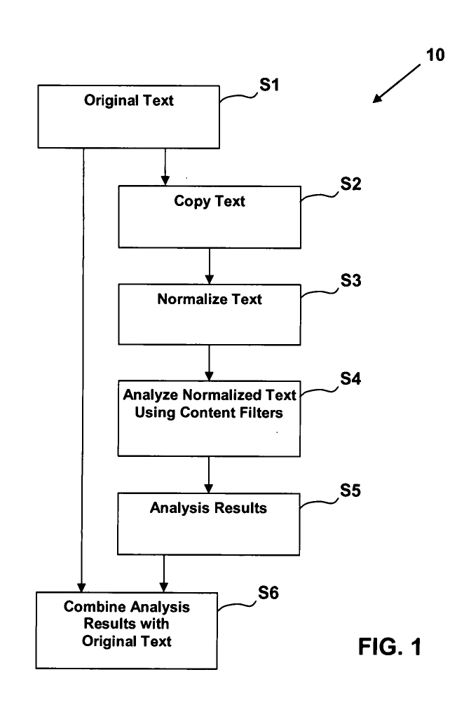

A flow diagram 10 of an illustrative process for preventing characters from bypassing content filters in accordance with an embodiment of the present invention is depicted in FIG. 1.

In step S1, the original text to be filtered by one or more content filters is provided/obtained in some manner. The text may comprise, for example, the subject and body of an email, instant message, web page content, a Universal Resource Locator (URL), etc. In step S2, a copy of the original text is made.

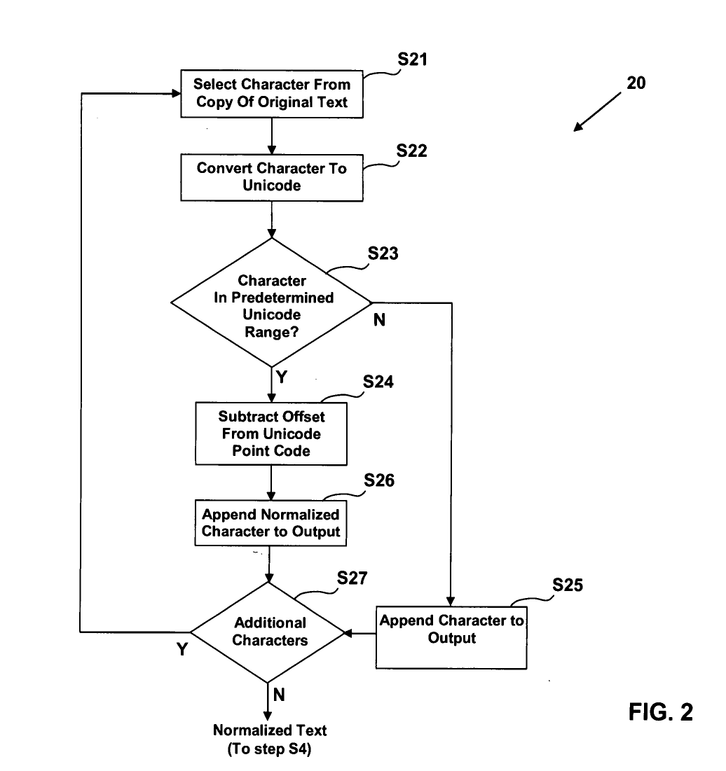

In step S3, the characters in the copy of the original text provided in step S2 are normalized, if necessary, to Unicode characters in the range of U+0021 through U+007E to provide normalized text. A flow diagram 20 of an illustrative process for normalizing the characters in the copy of the original text in accordance with an embodiment of the present invention is depicted in FIG. 2, and will be described in greater detail below.

The normalized text provided in step S3 is analyzed in a known manner in step S4, using one or more content filters, and the results of the analysis are provided in step S5. By making the copy of the original text in step S2, the original text is maintained and is not changed by the normalizing process. Further, since normalized text is analyzed in step S4, no changes are needed to the analysis logic and methods.

The analysis results provided in step S5 are combined with the original text provided/obtained in step S1. The results of the analysis may comprise, for example, a score indicating the likelihood that the original text is associated with an unsolicited email or with a web page containing undesirable content. Based on the score, an external program can route the original text accordingly (e.g., route an unsolicited email to a “junk” mail folder). Other methodologies for handling the original text in view of the analysis results are also possible and fall within the scope of the present invention.

Referring now to FIG. 2, there is illustrated a general flow diagram 20 of the text normalization step (step S3) of FIG. 1 in accordance with an embodiment of the present invention. In step S21, the first character from the copy of the original text provided in step S2 of FIG. 2 is selected. In step S22, the selected character is converted to its Unicode representation (if not already in Unicode). If the Unicode representation of the character is determined in step S23 to fall within a predetermined Unicode range, then flow passes to step S24. Otherwise flow passes to step S25, where the original character is appended to the output text of the normalization process.

In step S24, a predetermined offset is subtracted from the Unicode codepoint of the character to normalize the character to a Unicode character in the range of U+0021 through U+007E. For instance, if the character comprises a full width ASCII character equivalent in the range of U+FF01 through U+FF5E, then the offset that is subtracted from the Unicode codepoint is FEE0 (hex) or 65248 (decimal). As an example, when the offset of FEE0 (hex) is subtracted from the Unicode codepoint of FF21 (hex) corresponding to the full width ASCII character equivalent “A,” the result is 0041 (hex), which corresponds to the ASCII character “A.” Other offsets are possible, depending on the Unicode codepoint of the character to be normalized. After the character is normalized in step S24, the normalized character is appended to the output text of the normalization process in step S26. If it is determined in step S27 that there are additional characters in the copy of the original text, flow passes back to step S21. If there are no additional characters, the normalized text is provided to step S4 of FIG. 1.

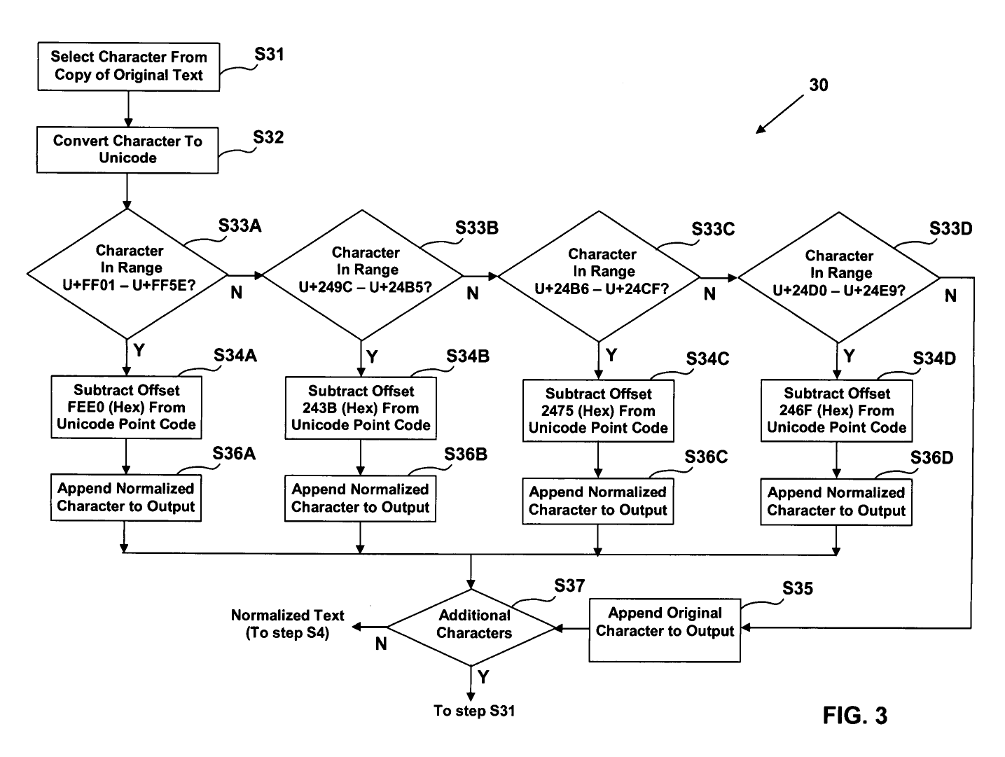

FIG. 3 depicts a more detailed flow diagram 30 of an illustrative process for normalizing text in accordance with an embodiment of the present invention. In step S31, the first character from the copy of the original text is selected. In step S32, the selected character is converted to its Unicode representation (if not already in Unicode). If the Unicode representation of the character is determined in step S33A to fall within the Unicode range of U+FF01 through U+FF5E, corresponding to a full width ASCII character equivalent, then flow passes to step S34A, where an offset of FEE0 (hex) is subtracted from the Unicode codepoint of the character. Otherwise flow passes to step S33B. The subtraction of the offset of FEE0 (hex) normalizes the character to its corresponding ASCII character within the Unicode range of U+0021 through U+007E. In step S36A, the normalized character is appended to the output text of the normalization process.

If the Unicode representation of the character is determined in step S33B to fall within the Unicode range of U+249C through U+24B 5, corresponding to a parenthesized lowercase Latin character, then flow passes to step S34B, where an offset of 243B (hex) is subtracted from the Unicode codepoint of the character. Otherwise flow passes to step S33C. The subtraction of the offset of 243B (hex) normalizes the character to its corresponding ASCII character within the Unicode range of U+0061 through U+007A. In step S36B, the normalized character is appended to the output text of the normalization process.

If the Unicode representation of the character is determined in step S33C to fall within the Unicode range of U+24B6 through U+24CF, corresponding to a circled uppercase Latin character, then flow passes to step S34C, where an offset of 2475 (hex) is subtracted from the Unicode codepoint of the character. Otherwise flow passes to step S33D. The subtraction of the offset of 2475 (hex) normalizes the character to its corresponding ASCII character within the Unicode range of U+0041 through U+005A. In step S36C, the normalized character is appended to the output text of the normalization process.

If the Unicode representation of the character is determined in step S33D to fall within the Unicode range of U+24D0 through U+24E9, corresponding to a circled lowercase Latin character, then flow passes to step S34D, where an offset of 246F (hex) is subtracted from the Unicode codepoint of the character. Otherwise flow passes to step S35, where the original character is appended to the output text of the normalization process. The subtraction of the offset of 246F (hex) normalizes the character to its corresponding ASCII character within the Unicode range of U+0061 through U+007A. In step S36D, the normalized character is appended to the output text of the normalization process.

If it is determined in step S37 that there are additional characters in the copy of the original text, flow passes back to step S31. If there are no additional characters, the normalized text is provided to step S4 of FIG. 1.

It should be noted that other Unicode ranges are possible and can be included in the process illustrated in FIG. 3. Further, the process can be applied to one or any combination of Unicode ranges that are arranged alphabetically from A to Z in order to prevent such characters from bypassing content filters.

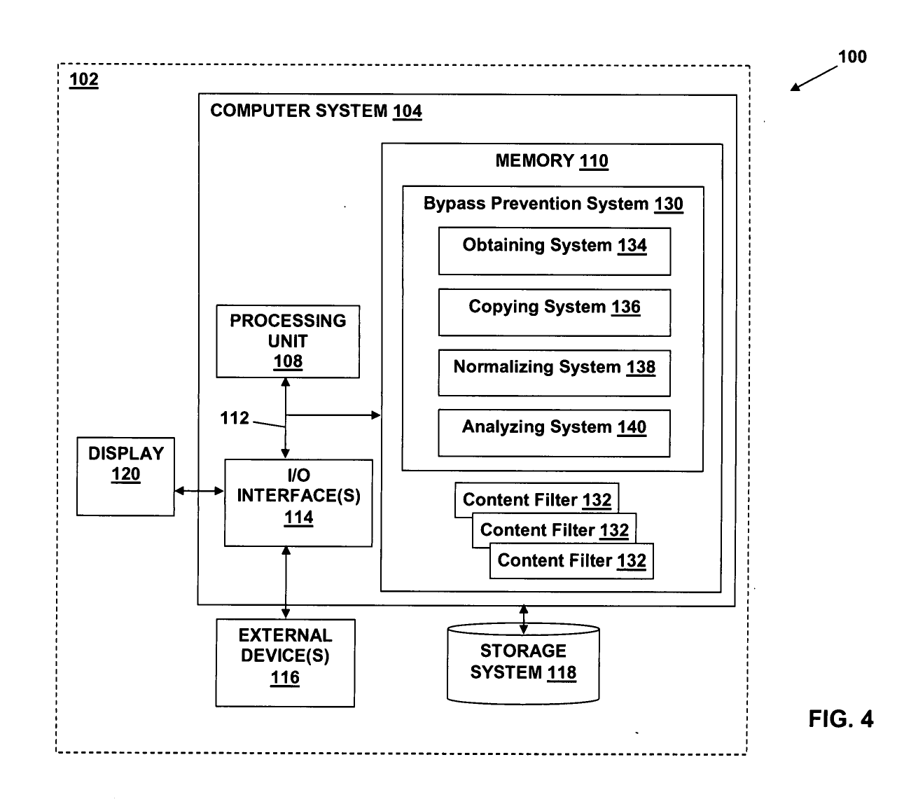

FIG. 4 shows an illustrative system 100 for preventing characters from bypassing content filters in accordance with embodiment(s) of the present invention. To this extent, the system 100 includes a computer infrastructure 102 that can perform the various process steps described herein for preventing characters from bypassing content filters. In particular, the computer infrastructure 102 is shown including a computer system 104 that comprises a bypass prevention system 130, which enables the computer system 104 to prevent characters from bypassing one or more content filters 132 by performing the process steps of the invention.

The computer system 104 is shown as including a processing unit 108, a memory 110, at least one input/output (I/O) interface 114, and a bus 112. Further, the computer system 104 is shown in communication with at least one external device 116 and a storage system 118. In general, the processing unit 108 executes computer program code, such as bypass prevention system 130, that is stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The at least one external device 116 can comprise any device (e.g., display 120) that enables a user (not shown) to interact with the computer system 104 or any device that enables the computer system 104 to communicate with one or more other computer systems.

In any event, the computer system 104 can comprise any general purpose computing article of manufacture capable of executing computer program code installed by a user (e.g., a personal computer, server, handheld device, etc.). However, it is understood that the computer system 104 and the bypass prevention system 130 are only representative of various possible computer systems that may perform the various process steps of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the invention. For example, in one embodiment, the computer infrastructure 102 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, the bypass prevention system 130 enables the computer system 104 to prevent characters from bypassing one or more content filters 132. To this extent, the bypass prevention system 130 is shown as including an obtaining system 134 for providing/obtaining the original text to be filtered by the one or more content filters 132 and a copying system 136 for making a copy of the original text. Also provided is a normalizing system 138 for normalizing the characters in the copy of the original text, if necessary, to Unicode ASCII characters in the range of U+0021 through U+007E to provide normalized text, and an analyzing system 140 for analyzing the normalized characters using the one or more content filters. Operation of each of these systems is discussed above. It is understood that some of the various systems shown in FIG. 4 can be implemented independently, combined, and/or stored in memory for one or more separate computer systems 104 that communicate over a network. Further, it is understood that some of the systems and/or functionality may not be implemented, or additional systems and/or functionality may be included as part of the system 100.

While shown and described herein as a method and system for preventing characters from bypassing content filters, it is understood that the invention further provides various alternative embodiments. For example, in one embodiment, the invention provides a computer-readable medium that includes computer program code to enable a computer infrastructure to prevent characters from bypassing content filters. To this extent, the computer-readable medium includes program code, such as the bypass prevention system 130, which implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to prevent characters from bypassing content filters as described above. In this case, the service provider can create, maintain, support, etc., a computer infrastructure, such as the computer infrastructure 102, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of preventing characters from bypassing content filters. In this case, a computer infrastructure, such as the computer infrastructure 102, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

1. A method for preventing characters from bypassing a content filter, comprising:
obtaining text to be analyzed;
normalizing the text by subtracting an offset from a numeric codepoint of each character in the text falling within a predetermined range; and
analyzing the normalized text using the content filter.

2. The method of claim 1, wherein the text is normalized to Unicode characters in a Unicode range of U+0021 through U+007E.

3. The method of claim 1, wherein the offset is subtracted from a Unicode codepoint of each character falling within a predetermined Unicode range.

4. The method of claim 3, wherein the predetermined Unicode range is U+FF01 through U+FF5E, corresponding to full width ASCII character equivalents.

5. The method of claim 3, wherein the predetermined Unicode range is at least one of:
U+FF01 through U+FF5E;
U+249C through U+24B5;
U+24B6 through U+24CF; and
U+24D0 through U+24E9.

6. The method of claim 1, wherein obtaining text further comprises:
obtaining original text; and
making a copy of the original text, wherein the normalizing is performed on the copy of the original text.

7. The method of claim 6, further comprising:
combining the original text and results of the analysis of the normalized text.

8. The method of claim 1, further comprising:
converting each non-Unicode character to Unicode before normalizing.

9. A system for preventing characters from bypassing a content filter, comprising:
a system for obtaining text to be analyzed;
a system for normalizing the text by subtracting an offset from a numeric codepoint of each character in the text falling within a predetermined range; and
a system for analyzing the normalized text using the content filter.

10. The system of claim 9, wherein the text is normalized to Unicode characters in a Unicode range of U+0021 through U+007E.

11. The system of claim 9, wherein the offset is subtracted from a Unicode codepoint of each character falling within a predetermined Unicode range.

12. The system of claim 11, wherein the predetermined Unicode range is U+FF01 through U+FF5E, corresponding to full width ASCII character equivalents.

13. The system of claim 11, wherein the predetermined Unicode range is at least one of:
U+FF01 through U+FF5E;
U+249C through U+24B5;
U+24B6 through U+24CF; and
U+24D0 through U+24E9.

14. The system of claim 9, wherein the system for obtaining text further comprises:
a system for obtaining original text; and
a system for making a copy of the original text, wherein the normalizing is performed on the copy of the original text.

15. The system of claim 14, further comprising:
a system for combining the original text and results of the analysis of the normalized text.

16. The system of claim 9, further comprising:
a system for converting each non-Unicode character to Unicode before normalizing.

17. A program product stored on a computer readable medium for preventing characters from bypassing a content filter, the computer readable medium comprising program code for performing the steps of:
obtaining text to be analyzed;
normalizing the text by subtracting an offset from a numeric codepoint of each character in the text falling within a predetermined range; and
analyzing the normalized text using the content filter.

18. The program product of claim 17, wherein the text is normalized to Unicode characters in a Unicode range of U+0021 through U+007E.

19. The program product of claim 17, wherein the offset is subtracted from a Unicode codepoint of each character falling within a predetermined Unicode range.

20. The program product of claim 19, wherein the predetermined Unicode range is at least one of:
U+FF01 through U+FF5E;
U+249C through U+24B5;
U+24B6 through U+24CF; and
U+24D0 through U+24E9.
